(19) United States
(12) Patent Application Publication
(10) Pub. No.: US 2005/0258758 A1
(43) Pub. Date: Nov. 24, 2005

(54) Resilient discharge lamp

(76) Inventor: Hilary Boehme, Hauppauge, NY (US)

Correspondence Address: Hilary Boehme, 375 Marcus Boulevard, Hauppauge, NY, 11788, US

(21) Appl. No.: 10/850,620

(22) Filed: May 21, 2004

(51) Int. Cl. H01J 17/20; H01J 61/12; H01J 61/30; H01J 17/16

(52) U.S. Cl. 313/634; 313/573

(57) ABSTRACT

A resilient discharge lamp. The resilient discharge lamp includes a tube, electrodes, and a gas. The electrodes are disposed at opposite ends of the tube, and the gas fills the tube. The tube is of such a diameter so as to be resilient and allow the resilient discharge lamp to be bent repetitively as desired. In an alternate embodiment, the opposite ends of the tube are widened to provide more space for the electrodes. In another alternate embodiment, the tube is bent onto itself so as to form a generally U-shape.

### BACKGROUND OF THE INVENTION

1. Field of the Invention

The present invention relates to a lamp, and more particularly, the present invention relates to a resilient discharge lamp.

2. Description of the Prior Art

There exists numerous innovations for bulbs in the prior art.

FOR EXAMPLE, U.S. Pat. No. 4,283,217 to Kawamura teaches an elongated envelope for a fluorescent light bulb that is held at each of its ends, and heated to a degree by which it is bendable. The ends are then moved relatively to each other in a path by which they are turned inwardly in opposition to each other and toward the center portion of the envelope while being directed out of the plane of the center portion to in part overly the center portion.

ANOTHER EXAMPLE, U.S. Pat. No. 4,337,414 to Young teaches a fluorescent lamp of high brightness and compact size is provided by forming the envelope from vitreous tubing that is bent upon itself in such a manner that the envelope has either five or seven U-shaped sections which are disposed in tridimensional array and define a single convoluted discharge channel. The U-shaped sections are so oriented that the tubular legs of the U's are positioned in side-by-side columnar relationship with each other and the sealed ends of the tubing are located adjacent one another. The lamp thus has an arc length that is more than six or eight times as long as the overall height dimension of the convoluted envelope and generates light in a very efficient manner. The retrobent fluorescent lamps are combined with a protective housing, a base structure and operating circuits of various types to provide convection-cooled lamp units that are small enough to be used in table lamps and similar lighting fixtures but have light outputs in excess of 1,500 lumens and efficacies in the order of 60 lumens per watt. Various arrangements for including the ballast and other circuit components either as integral parts of the lamp unit or as separate components which are housed in the lighting fixture and thus permitting the lamp units to be used as direct replacements for incandescent type lamps are disclosed. Method of manufacturing the various multi-U-bent envelopes from a single piece of glass tubing employing arcuate molding components and sequential bending operations are also disclosed.

STILL ANOTHER EXAMPLE, U.S. Pat. No. 4,908,055 to Komiya et al. teaches a manufacturing method of a fluorescent lamp having a bent discharge path, which comprises the steps of press-molding a straight glass tube, after heating and softening it, into a bulb having a bent discharge path, while blowing a pressurized gas into the discharge path. A fluorescent lamp having a U-shaped discharge path which is integrally connected through a narrow plate. A slit is formed at least in a portion of the narrow plate adjacent to a sealing portion.

YET ANOTHER EXAMPLE, U.S. Pat. No. 5,448,460 to Belfer et al. teach a bendable lighting fixture for fluorescent lighting which includes a plurality of support members, each having a mounting surface for receiving a fluorescent lamp; a socket for receiving a fluorescent lamp mounted on the mounting surface; a connector assembly for pivotally connecting each pair of adjacent support members; and the plurality of support members being movable relative to each other to form the lighting fixture into the desired curved shape.

STILL YET ANOTHER EXAMPLE, U.S. Patent Application Number 20020071276 to Blum teaches a lighting device having a selectably changeable shape. Such lighting device includes a flexible lighting element and an adjustable shape-retaining element coupled to the flexible lighting element which can be mounted in a transparent or translucent flexible covering. According to a preferred embodiment of the invention, the flexible lighting element is mounted in a flexible covering including the adjustable shape-retaining element. Preferably, the flexible covering is transparent or translucent. According to one embodiment of the invention, the flexible lighting element includes a rope light. According to another embodiment, the adjustable shape-retaining element is a metal wire. According to another embodiment of the invention, the adjustable shape-retaining element includes shapeable wires incorporated in at least part of the flexible covering. There is also provided a method for providing a shapeable lighting device, the method including coupling an adjustable shape-retaining element to a flexible lighting element. According to one embodiment of the invention, the method further includes mounting the flexible lighting element in a transparent or translucent flexible covering. According to another embodiment of the invention, the step of coupling includes providing an adjustable shape-retaining element in the flexible covering.

YET STILL ANOTHER EXAMPLE, U.S. Patent Application Number 0030128541 to Liu teaches a structure of twisted flexible lights that mainly includes a flexible light with pearlescent or other color pigments and a connector buried vertically; wherein, a plurality of strands of flexible lights are twisted together to make a colorful flexible light and that is further formed into an arcuation, an arch or crisscrossed arcuate shapes to be mounted onto the vertically buried connector thereby to make the style of the flexible light variable and the features thereof colorful, gorgeous and not easy to fade so as to achieve the practical and beautiful effect.

STILL YET ANOTHER EXAMPLE, U.S. Patent Application Number 20030206419 teaches a rope, for example a wire rope, that is equipped with a number of luminous elements. A luminous element may in this case assume the position of a wire or of a braid, may be integrated in an insert, or may be guided in the spaces between wires or braids and preferably within the theoretical rope circumference. The luminous element may also itself be composed of luminous elements which are twisted together, are twisted or are laid. For strain relief, the luminous elements may be equipped with a reinforcement in the form of a strand, or with a mesh. The luminous element is intended to be connected to a source. In the state when it is fed, the luminous element is actively luminous. Owing to the improved visibility, rope lights may be used not only for a safety function but also for an aesthetic appearance.

### SUMMARY OF THE INVENTION

ACCORDINGLY, IT IS AN OBJECT of the present invention to provide a resilient discharge lamp that has advantages not present in prior patent.

ANOTHER OBJECT of the present invention to provide a resilient discharge lamp that is easy to use.

BRIEFLY STATED, STILL ANOTHER OBJECT of the present invention to provide a resilient discharge lamp. The resilient discharge lamp includes a tube, electrodes, and a gas. The electrodes are disposed at opposite ends of the tube, and the gas fills the tube. The tube is of such a diameter so as to be resilient and allows the resilient discharge lamp to be bent repetitively as desired. In an alternate embodiment, the opposite ends of the tube are widened to provide more space for the electrodes. In another alternate embodiment, the tube is bent onto itself so as to form a generally U-shape.

### BRIEF DESCRIPTION OF THE DRAWINGS

The figures are briefly described as follows:

FIG. 1 is a diagrammatic front elevational view of a first embodiment of the present invention;

FIG. 2 is a diagrammatic front elevational view of a second embodiment of the present invention; and

FIG. 3 is a diagrammatic front elevational view of a third embodiment of the present invention.

### LIST OF REFERENCE NUMERALS UTILIZED IN THE DRAWINGS

### First Embodiment

10 resilient discharge lamp
12 tube
14 coating
16 electrodes
18 gas
20 opposite ends of tube 12

### Second Embodiment

110 resilient discharge lamp
112 tube
120 opposite ends of tube 112
116 electrodes

### Third Embodiment

210 resilient discharge lamp
212 tube

### DETAILED DESCRIPTION OF THE INVENTION

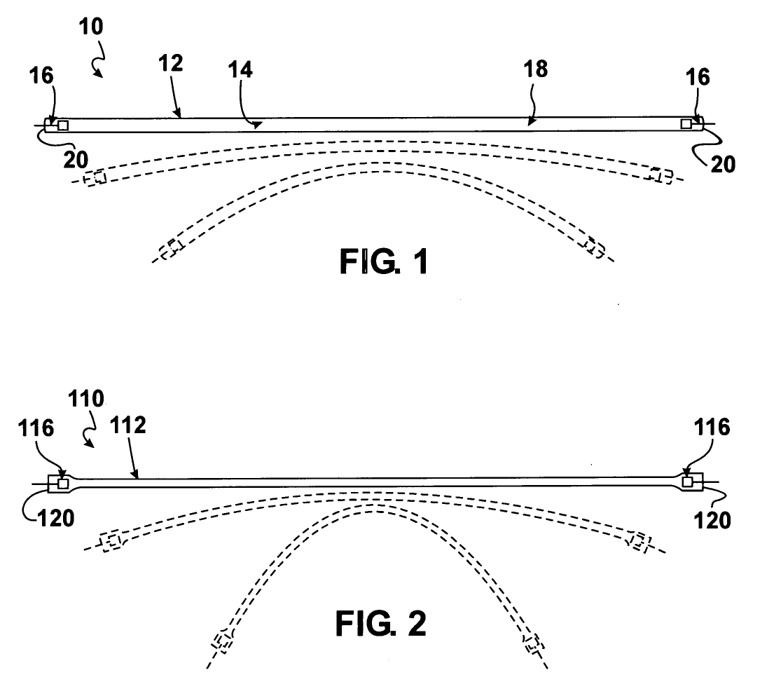

Referring now to the figures, in which like numerals indicate like part, and particularly to FIG. 1, which is a diagrammatic front elevational view of a first embodiment of the present invention, a first embodiment of the resilient discharge lamp of the present invention is shown generally at 10.

The resilient discharge lamp 10 comprises a tube 12, electrodes 16, and a gas 18. The electrodes 16 are disposed at opposite ends 20 of the tube 12. The gas 18 fills the tube 12.

The tube 12 is slender, elongated, and generally cylindrically-shaped, has an constant diameter, is made of glass, such as quartz, and is of such a diameter so as to be resilient and allow the resilient discharge lamp 10 to be bent repetitively as desired, for example as shown by dashed lines in FIG. 1.

The method of forming the tube 12 includes the following steps:
STEP 1: Heat tubular glass stock material until softened so as to form a softened tube.
STEP 2: Stretch the softened tube until the desired diameter is achieved so as to form a stretched softened tube.
STEP 3: Allow the stretched softened tube to cool so as to form a cooled stretched tube.
STEP 4: Cut the cooled stretched tube to a desired length so as to form the tube 12.

### EXAMPLE I

A first tube 12 having a 0.35 mm diameterwas bent and yielded an approximate bend radius of 70 mm

### EXAMPLE II

A second tube 12 having a 0.38 mm diameter was bent and yielded an approximate bend radius of 75 mm.

### EXAMPLE III

A third tube 12 having a 0.41 mm diameter was bent and yielded an approximate bend radius of 80 mm.

### EXAMPLE IV

A fourth tube 12 having a 0.51 mm diameter was bent and yielded an approximate bend radius of 80 mm.

### EXAMPLE V

A fifth tube 12 having a 1.04 mm diameter was bent and yielded an approximate bend radius of 200 mm.

### EXAMPLE VI

A sixth tube 12 having a 1.40 mm diameter was bent and yielded an approximate bend radius of 200 mm.

The results of the above six examples are tabulated infra in TABLE I.

| | | APPROXIMATE BEND |
|---|---|---|
| TUBE NUMBER | TUBE DIAMETER (mm) | RADIUS (mm) |
| 1 | .35 | 70 |
| 2 | .38 | 75 |
| 3 | .41 | 80 |
| 4 | .51 | 80 |
| 5 | 1.04 | 200 |
| 6 | 1.40 | 200 |

A second embodiment of the resilient discharge lamp 110 can best be seen in FIG. 2, which is a diagrammatic front elevational view of a second embodiment of the present invention, and as such, will be discussed with reference thereto.

The resilient discharge lamp 110 is similar to the discharge lamp bulb 10, except that the opposite ends 120 of the tube 112 are widened to provide more space for the electrodes 116.

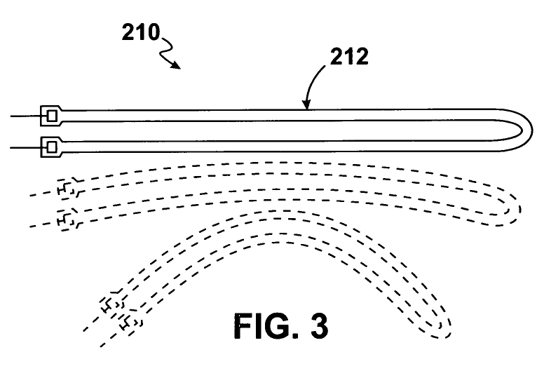

A third embodiment of the resilient discharge lamp 210 can best be seen in FIG. 3, which is a diagrammatic front elevational view of a third embodiment of the present invention, and as such, will be discussed with reference thereto.

The resilient discharge lamp 210 is similar to the resilient discharge lamp 10, 110, except that the tube 212 is bent onto itself so as to form a generally U-shape.

1. A resilient discharge lamp, comprising:
a) a tube;
b) electrodes; and
c) a gas;
wherein said electrodes are disposed at opposite ends of said tube;
wherein said gas fills said tube; and
wherein said tube is of such a diameter so as to be resilient and allow said resilient discharge lamp to be bent repetitively as desired.

2. The lamp as defined in claim 1, wherein said tube is slender;
wherein said tube is elongated; and
wherein said tube is generally cylindrically-shaped.

3. The lamp as defined in claim 1, wherein said tube has a constant diameter.

4. The lamp as defined in claim 1, wherein said tube is made of glass.

5. The lamp as defined in claim 1, wherein said tube is made of quartz.

6. The lamp as defined in claim 1, wherein said opposite ends of said tube are widened to provide more space for said electrodes.

7. The lamp as defined in claim 1, wherein said tube is bent onto itself so as to form a generally U-shape.

8. A method of forming a tube for use in a resilient discharge lamp that allows the resilient discharge lamp to be repetitively bent as desired, comprising the steps of:
a) heating tubular glass stock material until softened so as to form a softened tube;
b) stretching the softened tube until a desired diameter is achieved so as to form a stretched softened tube; and
c) allowing the stretched softened tube to cool so as to form a cooled stretched tube.

9. The method as defined in claim 8; further comprising the step of cutting said cooled stretched tube to a desired length so as to form the tube.
